(19) United States
(12) Patent Application Publication
(10) Pub. No.: US 2025/0225182 A1
(43) Pub. Date: Jul. 10, 2025

(54) method of improving text vectorization using depth-first search and radix trees

(71) Applicant: Verses Technologies USA, Inc., Los Angeles, CA (US)

(72) Inventor: Sara K. Brazille, Montreal (CA)

(21) Appl. No.: 19/004,267

(22) Filed: Dec. 28, 2024

Related U.S. Application Data
(60) Provisional application No. 63/618,776, filed on Jan. 8, 2024.

(51) Int. Cl. G06F 16/901; G06F 16/22

(52) U.S. Cl. CPC G06F 16/9024; G06F 16/2237

(57) ABSTRACT

Method of achieving improvement in the vectorization of text data. The method comprises a vector search method that includes searching a word or part of a word in a depth-first approach by searching down a radix tree for the longest string available in a database that corresponds to the word or sentence being vectorized and moving back up the tree as the longest string is not found and the next shorter string needs to be selected.

### FIELD OF INVENTION

This invention concerns the field of text vectorization.

### BACKGROUND

Text vectorization is the process of converting raw text data (i.e., data in natural language) into vectors of real numbers (e.g., [1 0 1 0 1 1 1]) that can be interpreted by computer programs. Text vectorization is a ubiquitous method in Natural Language Processing, used in most computer based technologies that involve taking in as inputs, texts in natural language. Text vectorization involves two key steps:

Vector search: Splitting the sentence into components that will be searched in a database to find the vectors that match them.

Vector computation: Performing mathematical operations over all the vectors found for the components of the sentence, so as to obtain a single vector that combines all the component vectors.

FastText is an industry standard vectorization software. The vectorization time for the average sentence in FastText is 1/60000 of a second. In cases where the vector for a word cannot be found, which is often the case for very long words, the vectorization will fail and will not generate the final vector for the sentence.

### SUMMARY OF THE INVENTION

According to the present invention, there is provided a method of achieving improvement in the processes of text vectorization over those of industry standard software. The improvement provides the benefit of (i) vectorizing the average sentence in 1/3000000 of a second, which is a 5000% speed improvement, and by (ii) allowing for the vectorization of sentences that include complex words absent in the database. The present invention improves on vector search by using a tokenization method whereby a computer program finds the longest strings of a word available in the database, as discussed further below, by using a depth-first search method. The search for vectors associated with a word is done through a radix tree. Radix tree is an architecture that can be defined in the form of a database and uses a data structure that represents data as nodes (that can include parent and child nodes) and which may be related to leaves containing the vector numbers associated with a section that is defined by a node or group of nodes. The sections of the graph database group either individual nodes forming single element strings, or groups of nodes forming multiple elements strings. Radix trees have a discrete structure where each parent node is connected to its children node, and that is searched using a computer program. The claimed invention covers any method that includes splitting sentences into their longest representatives in the database, which defines a database with discrete data structures, and which stores data using parent-children relationships between nodes, which for ease of reference will be defined herein as a radix tree architecture database.

Thus, according to the invention there is provided a method of achieving improvement in the vectorization of text data, comprising, storing data about words, parts of words, sentences, or parts of sentences in a database, wherein the database defines a discrete architecture representing the data about words, parts of words, sentences, or parts of sentences as a graph and associating each word, part of a word, sentence, or part of a sentence with a vector, and searching the words, parts of words, sentences, or parts of sentences in the database by running iteratively from top to bottom through the database and moving back up the database as the longest string is not found and the next shorter string needs to be selected, until the longest available string is located, and wherein the vector associated with the longest string is used as the vector for the word, parts of words, sentences, or parts of sentences being searched, and creating a final vector representing the words, parts of words, sentences, or parts of sentences being vectorized, wherein the storing, searching, and creating is done using a computer program.

The graph database may be structured in sections that either contain single nodes or groups of individual nodes representing string elements, and wherein each section possesses a leaf containing a vector number associated with the section, and wherein the sections are organized in a top-down relationship, from the section containing the smallest set of nodes, to the section containing the largest set of nodes.

The vectorization may involve searching through the graph database for the section containing the longest string that matches the words, parts of words, sentences, or parts of sentences being vectorized.

The text to be vectorized may be searched from left to right, and the final vector may include a combination of each iteratively found vector in the order in which it was found in the database.

### BRIEF DESCRIPTION OF THE DRAWINGS:

FIG. 1 is a flow diagram showing a prior art implementation of vector search and vector computation using industry standard vectorization processes, and

FIG. 2 is a flow diagram of one embodiment of an implementation of a method of improving text vectorization according to the invention.

### DETAILED DESCRIPTION

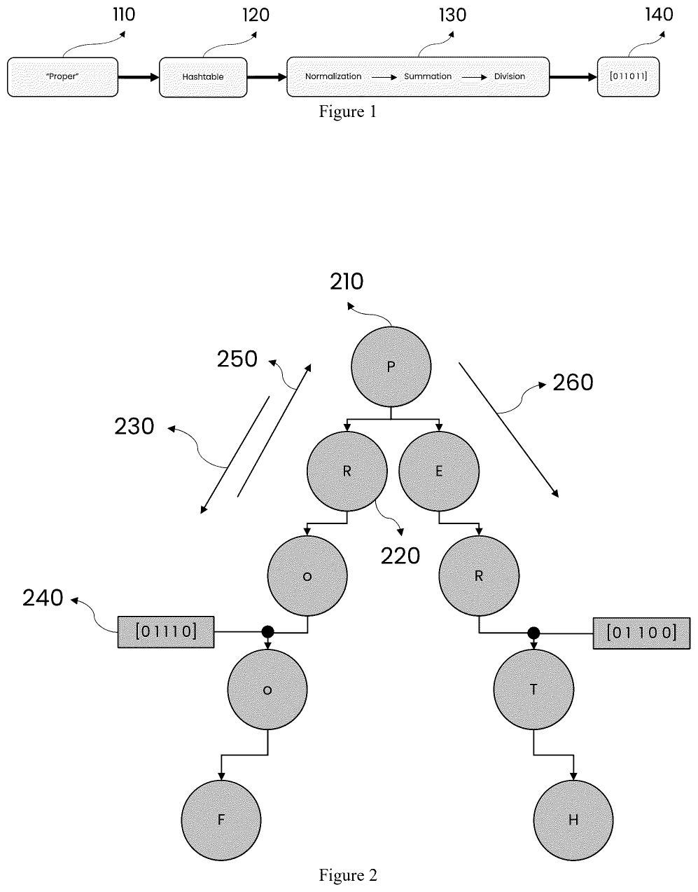

FIG. 1 shows a typical prior art implementation, in programming language, of vector search and vector computation using industry standard vectorization processes such as FastText that involves an input 110 that corresponds to a sentence or word such as “proper”. The input is processed using a vector search method that looks for the word's vector through a hash table 120 as known in the art (Konheim, A. G. (2010). Hashing in Computer Science: Fifty Years of Slicing and Dicing. John Wiley & Sons). If the word does not exist in the database, which is common for long and complex words or when the text to be vectorized is very large, the vectorization process will halt and not be completed. A vector computation method 130 is used to normalize each vector in case of a sentence involving multiple vectors. It then sums the vectors and divides the sum by the number of vectors to obtain a single vector that is the vector of the sentence 140.

FIG. 2 shows one implementation of a method of improving text vectorization according to the invention, using a tokenization method whereby a computer program finds the longest strings of a word available in the database as discussed further below by using a depth- first search method. The invention replaces the step 120 in FIG. 1 with the tokenization method depicted, by way of example, here in FIG. 2. The search for vectors associated with a word is done through a radix tree. The radix tree is obtained by converting the hashmap data structure used by industry standard vectorization software into a radix tree with conversion methods as known in the arts (for an example of equivalent approach, see Se Kwon Lee, K Hyun Lim, Hyunsub Song, Beomseok Nam, and Sam H Noh. 2017. {WORT}: Write Optimal Radix Tree for Persistent Memory Storage Systems. In 15th USENIX Conference on File and Storage Technologies (FAST 17). 257-270). The radix tree has nodes that contain a single character and leaves that contain vector numbers. The radix tree is made of parent nodes (e.g., P) 210 related to children nodes (e.g., R) 220. The depth-first search method starts from the top of the tree and goes down 230 to try to find the longest instance of the word (e.g., “Proper”). If the tree does not contain the word, the search will try to find the vector for the longest strings of portions of the word that can be combined to form the vector of the full word. If one of the words in the tree is “proof” (e.g., the left branch of the tree in FIG. 2), the search will stop at the second “O” and move upward (as depicted by arrow 250) node by node to see if a vector may be available for a portion of the word being searched. For instance, after reaching the second “O”, the search will run backward to check for a vector at “PRO” 240, “PR”, and “P”. The same process will apply to all the branches, from top to bottom, going down (260) and up if needed, until all of the vectors for the full word or sentence have been found. In FIG. 2, the vector for the sequence of characters “PRO” out of the word “Proof”' was available, and the vector for the word “PER” out of the word “Perth” was available. An industry standard vector computation method is used to normalize each vector, sum the vectors, and divide the sum by the number of vectors to obtain a single vector that is the vector of the sentence. The method of the invention achieves an improvement in the process of text vectorization over those of industry standard software by increasing the speed of industry vectorization by 5000%. This is rendered possible by the fact that the portions of the word or sentence being searched will be found much faster than the full words, which may or may not be included in the database. That is, searching “Pro” and “per” separately letter by letter is faster than searching “proper” since “pro” and “per” understood as sequences “p″″r″″ o” and “p″″e″″r” will be part of many different words that will be arrived at long before arriving at the full word “proper”.

What is claimed:

1. A method of achieving improvement in the vectorization of text data, comprising,
storing data about words, parts of words, sentences, or parts of sentences in a database, wherein the database defines a discrete architecture representing the data about words, parts of words, sentences, or parts of sentences as a graph and associating each word, part of a word, sentence, or part of a sentence with a vector, and
searching the words, parts of words, sentences, or parts of sentences in the database by running iteratively from top to bottom through the database and moving back up the database as the longest string is not found and the next shorter string needs to be selected, until the longest available string is located, and wherein the vector associated with the longest string is used as the vector for the word, parts of words, sentences, or parts of sentences being searched, and
creating a final vector representing the words, parts of words, sentences, or parts of sentences being vectorized, wherein the storing, searching, and creating is done using a computer program.

2. A method of claim 1 wherein the graph database is structured in sections that either contain single nodes or groups of individual nodes representing string elements, and wherein each section possesses a leaf containing a vector numbers associated with the section, and wherein the sections are organized in a top-down relationship, from the section containing the smallest set of nodes, to the section containing the largest set of nodes.

3. A method of claim 1 wherein the vectorization involves searching through the graph database for the section containing the longest string that matches the words, parts of words, sentences, or parts of sentences being vectorized.

4. A method of claim 1 wherein the text be to be vectorized is searched from left to right, and the final vector includes combining each iteratively found vector in the order in which it was found in the database.
